(19) United States
(12) Patent Application Publication
(10) Pub. No.: US 2014/0361987 A1
(43) Pub. Date: Dec. 11, 2014

(54) Eye controls

(71) Applicant: Sony Computer Entertainment Europe Limited, London (GB)

(72) Inventors: Ian Henry Bickerstaff, London (GB); Simon Mark Benson, London (GB); Sharwin Winesh Raghoebardayal, London (GB)

(21) Appl. No.: 14/300,707

(22) Filed: Jun. 10, 2014

(30) Foreign Application Priority Data
Jun. 11, 2013 (GB) 1310379.1
Aug. 21, 2013 (GB) 1314983.6
Mar. 17, 2014 (GB) 1404742.7

(51) Int. Cl. G06F 3/01; G02B 27/01

(52) U.S. Cl. CPC G06F 3/013; G02B 27/017
USPC 345/156

(57) ABSTRACT

A head mountable display (HMD) system in which images are generated for display to the user comprises an eyes-shut detector configured to detect a user's eye or eyes being shut; and an image generator configured to generate images for display by the HMD, the image generator being configured to carry out actions in response, at least in part, to a detection of whether the HMD wearer has one or both eyes shut for at least a first predetermined period, the image generator executing different respective actions in dependence upon: (i) a detection that the user's eyes are shut for at least the first predetermined period but less than a second predetermined period, the second predetermined period being longer than the first predetermined period; and (ii) a detection that the user's eyes are shut for at least the second predetermined period.

### CROSS REFERENCE TO RELATED APPLICATION

The present application claims the benefit of the earlier filing dates of GB1310379.1, GB1314983.6 and GB1404742.7 filed in the United Kingdom Patent Office on 11 Jun. 2013, 21 Aug. 2013 and 17 Mar. 2014 respectively, the entire contents of which applications are incorporated herein by reference.

### BACKGROUND

1. Field of the Disclosure

This invention relates to head-mountable apparatus and systems.

2. Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

A head-mountable display (HMD) is one example of a head-mountable apparatus. Audio headphones comprising a frame supporting one or more audio transducers are another example of a head-mountable apparatus. A head-mounted torch or light is a further example of a head-mountable apparatus. The following background discussions will relate mainly to HMDs, but the principles are also applicable to other types of head-mountable apparatus.

In an HMD, an image or video display device is provided which may be worn on the head or as part of a helmet. Either one eye or both eyes are provided with small electronic display devices.

Some HMDs allow a displayed image to be superimposed on a real-world view. This type of HMD can be referred to as an optical see-through HMD and generally requires the display devices to be positioned somewhere other than directly in front of the users eyes. Some way of deflecting the displayed image so that the user may see it is then required. This might be through the use of a partially reflective mirror placed in front of the user's eyes so as to allow the user to see through the mirror but also to see a reflection of the output of the display devices. In another arrangement, disclosed in EP-A-1 731 943 and US-A-2010/0157433, a waveguide arrangement employing total internal reflection is used to convey a displayed image from a display device disposed to the side of the user's head so that the user may see the displayed image but still see a view of the real world through the waveguide. Once again, in either of these types of arrangement, a virtual image of the display is created (using known techniques) so that the user sees the virtual image at an appropriate size and distance to allow relaxed viewing. For example, even though the physical display device may be tiny (for example, 10 mm×10 mm) and may be just a few millimetres from the user's eye, the virtual image may be arranged so as to be perceived by the user at a distance of (for example) 20 m from the user, having a perceived size of 5 m×5 m.

Other HMDs, however, allow the user only to see the displayed images, which is to say that they obscure the real world environment surrounding the user. This type of HMD can position the actual display devices in front of the user's eyes, in association with appropriate lenses or other optical components which place a virtual displayed image at a suitable distance for the user to focus in a relaxed manner—for example, at a similar virtual distance and perceived size as the optical see-through HMD described above. This type of device might be used for viewing movies or similar recorded content, or for viewing so-called virtual reality content representing a virtual space surrounding the user. It is of course however possible to display a real-world view on this type of HMD, for example by using a forward-facing camera to generate images for display on the display devices.

Although the original development of HMDs was perhaps driven by the military and professional applications of these devices, HMDs are becoming more popular for use by casual users in, for example, computer game or domestic computing applications.

The foregoing paragraphs have been provided by way of general introduction, and are not intended to limit the scope of the following claims. The described embodiments, together with further advantages, will be best understood by reference to the following detailed description taken in conjunction with the accompanying drawings.

Various aspects and features of the present invention are defined in the appended claims and within the text of the accompanying description and include at least a head mountable apparatus such as a display and a method of operating a head-mountable apparatus as well as a computer program.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an HMD worn by a user;

FIG. 2 is a schematic plan view of an HMD;

FIG. 3 schematically illustrates the formation of a virtual image by an HMD;

FIG. 4 schematically illustrates another type of display for use in an HMD;

FIG. 5 schematically illustrates a pair of stereoscopic images;

FIGS. 6 and 7 schematically illustrate a user wearing an HMD connected to a Sony® PlayStation 3® games console;

FIG. 8 schematically illustrates a change of view of user of an HMD;

FIGS. 9a and 9b schematically illustrate HMDs with motion sensing;

FIG. 10 schematically illustrates a position sensor based on optical flow detection;

FIG. 11 schematically illustrates the generation of images in response to HMD position or motion detection;

FIG. 12 is a further schematic plan view of an HMD;

FIG. 13 schematically illustrates a pair of eye tracking images;

FIG. 14 schematically illustrates another technique for capturing eye tracking images;

FIG. 15 schematically illustrates a user menu;

FIG. 16 schematically illustrates game environment hotspots;

FIG. 17 schematically illustrates a control technique according to eye orientation detection;

FIG. 18 schematically illustrates a control technique according to a detection of whether the eyes are open or shut; and

FIG. 19 is a schematic flowchart illustrating operations of the apparatus of FIG. 18.

### DESCRIPTION OF THE EMBODIMENTS

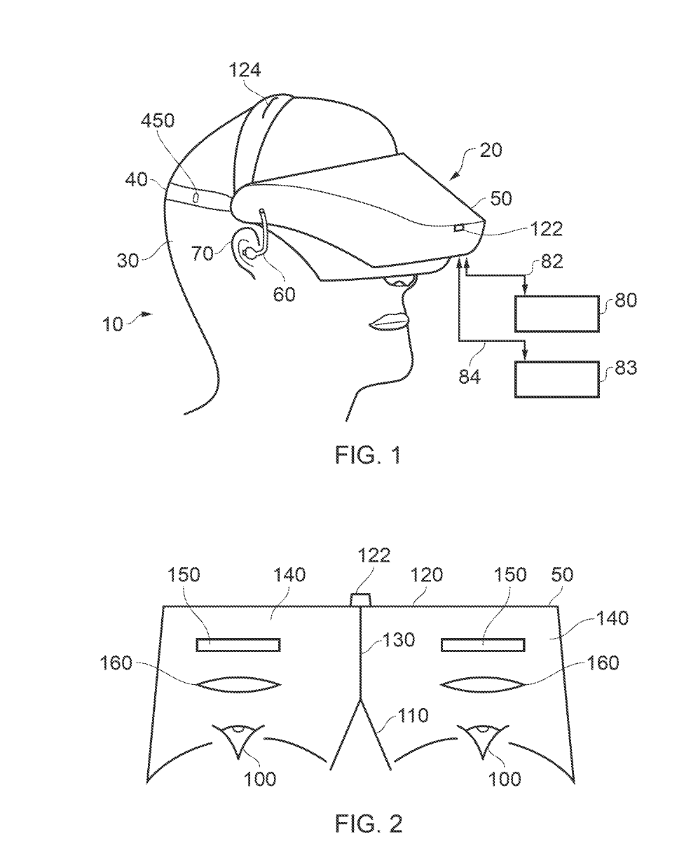

Referring now to FIG. 1, a user 10 is wearing an HMD 20 (as an example of a generic head-mountable apparatus—other examples including audio headphones or a head-mountable light source) on the user's head 30. The HMD comprises a frame 40, in this example formed of a rear strap and a top strap, and a display portion 50.

Note that the HMD of FIG. 1 may comprise further features, to be described below in connection with other drawings, but which are not shown in FIG. 1 for clarity of this initial explanation.

The HMD of FIG. 1 completely (or at least substantially completely) obscures the user's view of the surrounding environment. All that the user can see is the pair of images displayed within the HMD.

The HMD has associated headphone audio transducers or earpieces 60 which fit into the users left and right ears 70. The earpieces 60 replay an audio signal provided from an external source, which may be the same as the video signal source which provides the video signal for display to the users eyes.

The combination of the fact that the user can see only what is displayed by the HMD and, subject to the limitations of the noise blocking or active cancellation properties of the earpieces and associated electronics, can hear only what is provided via the earpieces, mean that this HMD may be considered as a so-called “full immersion” HMD. Note however that in some embodiments the HMD is not a full immersion HMD, and may provide at least some facility for the user to see and/or hear the user's surroundings. This could be by providing some degree of transparency or partial transparency in the display arrangements, and/or by projecting a view of the outside (captured using a camera, for example a camera mounted on the HMD) via the HMD's displays, and/or by allowing the transmission of ambient sound past the earpieces and/or by providing a microphone to generate an input sound signal (for transmission to the earpieces) dependent upon the ambient sound.

A front-facing camera 122 may capture images to the front of the HMD, in use. A Bluetooth® antenna 124 may provide communication facilities or may simply be arranged as a directional antenna to allow a detection of the direction of a nearby Bluetooth transmitter.

In operation, a video signal is provided for display by the HMD. This could be provided by an external video signal source 80 such as a video games machine or data processing apparatus (such as a personal computer), in which case the signals could be transmitted to the HMD by a wired or a wireless connection 82. Examples of suitable wireless connections include Bluetooth® connections. Audio signals for the earpieces 60 can be carried by the same connection. Similarly, any control signals passed from the HMD to the video (audio) signal source may be carried by the same connection. Furthermore, a power supply 83 (including one or more batteries and/or being connectable to a mains power outlet) may be linked by a cable 84 to the HMD. Note that the power supply 83 and the video signal source 80 may be separate units or may be embodied as the same physical unit. There may be separate cables for power and video (and indeed for audio) signal supply, or these may be combined for carriage on a single cable (for example, using separate conductors, as in a USB cable, or in a similar way to a “power over Ethernet” arrangement in which data is carried as a balanced signal and power as direct current, over the same collection of physical wires). The video and/or audio signal may be carried by, for example, an optical fibre cable. In other embodiments, at least part of the functionality associated with generating image and/or audio signals for presentation to the user may be carried out by circuitry and/or processing forming part of the HMD itself. A power supply may be provided as part of the HMD itself.

One or more vibration actuators (not shown) may be provided as part of the HMD arrangement for providing haptic feedback to the user. This feature will be discussed further below.

Some embodiments of the invention are applicable to an HMD having at least one electrical and/or optical cable linking the HMD to another device, such as a power supply and/or a video (and/or audio) signal source. So, embodiments of the invention can include, for example:

(a) an HMD having its own power supply (as part of the HMD arrangement) but a cabled connection to a video and/or audio signal source;

(b) an HMD having a cabled connection to a power supply and to a video and/or audio signal source, embodied as a single physical cable or more than one physical cable;

(c) an HMD having its own video and/or audio signal source (as part of the HMD arrangement) and a cabled connection to a power supply; or

(d) an HMD having a wireless connection to a video and/or audio signal source and a cabled connection to a power supply.

If one or more cables are used, the physical position at which the cable 82 and/or 84 enters or joins the HMD is not particularly important from a technical point of view. Aesthetically, and to avoid the cable(s) brushing the user's face in operation, it would normally be the case that the cable(s) would enter or join the HMD at the side or back of the HMD (relative to the orientation of the user's head when worn in normal operation). Accordingly, the position of the cables 82, 84 relative to the HMD in FIG. 1 should be treated merely as a schematic representation.

Accordingly, the arrangement of FIG. 1 provides an example of a head-mountable display system comprising a frame to be mounted onto an observer's head, the frame defining one or two eye display positions which, in use, are positioned in front of a respective eye of the observer and a display element mounted with respect to each of the eye display positions, the display element providing a virtual image of a video display of a video signal from a video signal source to that eye of the observer.

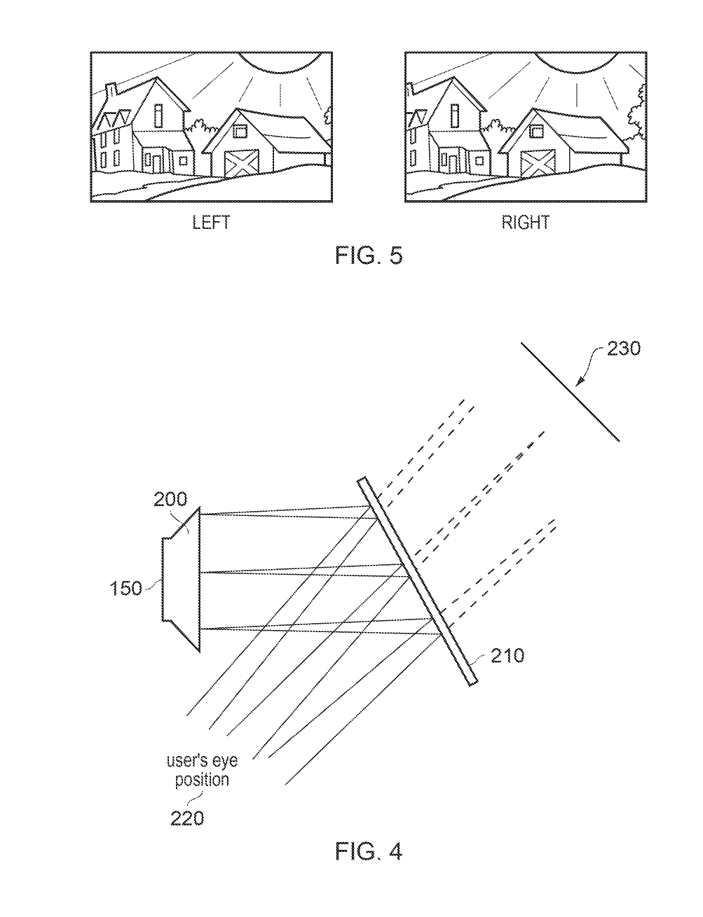

FIG. 1 shows just one example of an HMD. Other formats are possible: for example an HMD could use a frame more similar to that associated with conventional eyeglasses, namely a substantially horizontal leg extending back from the display portion to the top rear of the user's ear, possibly curling down behind the ear. In other (not full immersion) examples, the users view of the external environment may not in fact be entirely obscured; the displayed images could be arranged so as to be superposed (from the user's point of view) over the external environment. An example of such an arrangement will be described below with reference to FIG. 4.

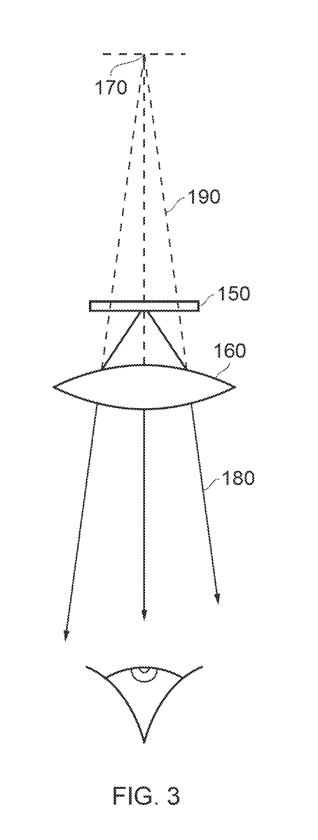

In the example of FIG. 1, a separate respective display is provided for each of the user's eyes. A schematic plan view of how this is achieved is provided as FIG. 2, which illustrates the positions 100 of the users eyes and the relative position 110 of the users nose. The display portion 50, in schematic form, comprises an exterior shield 120 to mask ambient light from the users eyes and an internal shield 130 which prevents one eye from seeing the display intended for the other eye. The combination of the users face, the exterior shield 120 and the interior shield 130 form two compartments 140, one for each eye. In each of the compartments there is provided a display element 150 and one or more optical elements 160. The way in which the display element and the optical element(s) cooperate to provide a display to the user will be described with reference to FIG. 3.

Referring to FIG. 3, the display element 150 generates a displayed image which is (in this example) refracted by the optical elements 160 (shown schematically as a convex lens but which could include compound lenses or other elements) so as to generate a virtual image 170 which appears to the user to be larger than and significantly further away than the real image generated by the display element 150. As an example, the virtual image may have an apparent image size (image diagonal) of more than 1 m and may be disposed at a distance of more than 1 m from the user's eye (or from the frame of the HMD). In general terms, depending on the purpose of the HMD, it is desirable to have the virtual image disposed a significant distance from the user. For example, if the HMD is for viewing movies or the like, it is desirable that the user's eyes are relaxed during such viewing, which requires a distance (to the virtual image) of at least several metres. In FIG. 3, solid lines (such as the line 180) are used to denote real optical rays, whereas broken lines (such as the line 190) are used to denote virtual rays.

An alternative arrangement is shown in FIG. 4. This arrangement may be used where it is desired that the users view of the external environment is not entirely obscured. However, it is also applicable to HMDs in which the users external view is wholly obscured. In the arrangement of FIG. 4, the display element 150 and optical elements 200 cooperate to provide an image which is projected onto a mirror 210, which deflects the image towards the user's eye position 220. The user perceives a virtual image to be located at a position 230 which is in front of the user and at a suitable distance from the user.

In the case of an HMD in which the users view of the external surroundings is entirely obscured, the mirror 210 can be a substantially 100% reflective mirror. The arrangement of FIG. 4 then has the advantage that the display element and optical elements can be located closer to the centre of gravity of the users head and to the side of the user's eyes, which can produce a less bulky HMD for the user to wear. Alternatively, if the HMD is designed not to completely obscure the user's view of the external environment, the mirror 210 can be made partially reflective so that the user sees the external environment, through the mirror 210, with the virtual image superposed over the real external environment.

In the case where separate respective displays are provided for each of the user's eyes, it is possible to display stereoscopic images. An example of a pair of stereoscopic images for display to the left and right eyes is shown in FIG. 5. The images exhibit a lateral displacement relative to one another, with the displacement of image features depending upon the (real or simulated) lateral separation of the cameras by which the images were captured, the angular convergence of the cameras and the (real or simulated) distance of each image feature from the camera position.

Note that the lateral displacements in FIG. 5 could in fact be the other way round, which is to say that the left eye image as drawn could in fact be the right eye image, and the right eye image as drawn could in fact be the left eye image. This is because some stereoscopic displays tend to shift objects to the right in the right eye image and to the left in the left eye image, so as to simulate the idea that the user is looking through a stereoscopic window onto the scene beyond. However, some HMDs use the arrangement shown in FIG. 5 because this gives the impression to the user that the user is viewing the scene through a pair of binoculars. The choice between these two arrangements is at the discretion of the system designer.

In some situations, an HMD may be used simply to view movies and the like. In this case, there is no change required to the apparent viewpoint of the displayed images as the user turns the user's head, for example from side to side. In other uses, however, such as those associated with virtual reality (VR) or augmented reality (AR) systems, the user's viewpoint needs to track movements with respect to a real or virtual space in which the user is located.

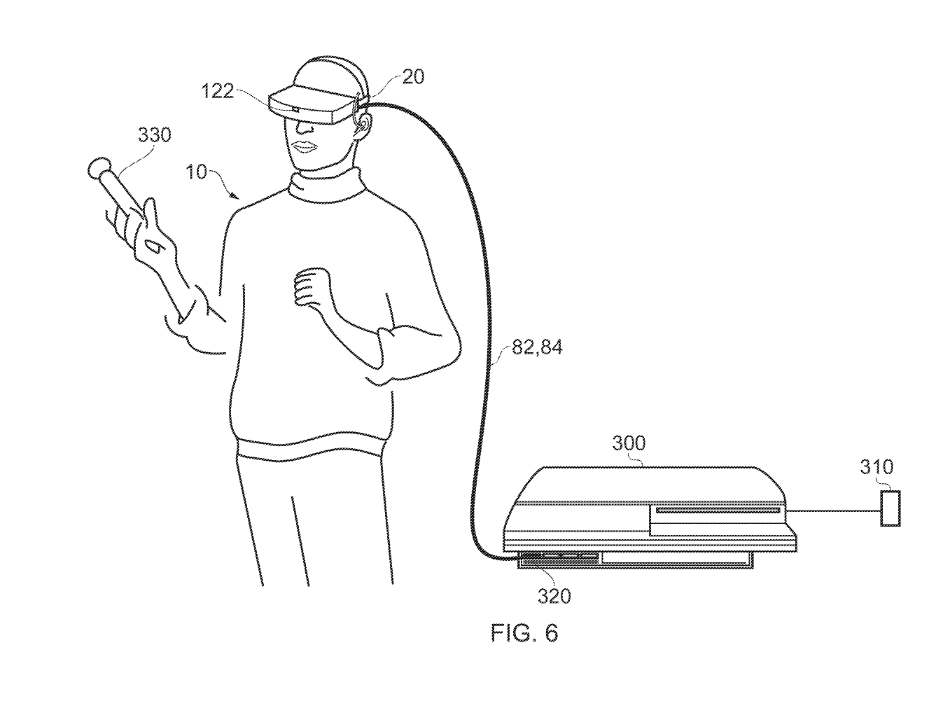

FIG. 6 schematically illustrates a user wearing an HMD connected to a Sony® PlayStation 3® games console 300 as an example of a base device. The games console 300 is connected to a mains power supply 310 and (optionally) to a main display screen (not shown). A cable, acting as the cables 82, 84 discussed above (and so acting as both power supply and signal cables), links the HMD 20 to the games console 300 and is, for example, plugged into a USB socket 320 on the console 300. Note that in the present embodiments, a single physical cable is provided which fulfils the functions of the cables 82, 84. In FIG. 6, the user is also shown holding a hand-held controller 330 which may be, for example, a Sony® Move® controller which communicates wirelessly with the games console 300 to control (or to contribute to the control of) game operations relating to a currently executed game program.

The video displays in the HMD 20 are arranged to display images generated by the games console 300, and the earpieces 60 in the HMD 20 are arranged to reproduce audio signals generated by the games console 300. Note that if a USB type cable is used, these signals will be in digital form when they reach the HMD 20, such that the HMD 20 comprises a digital to analogue converter (DAC) to convert at least the audio signals back into an analogue form for reproduction.

Images from the camera 122 mounted on the HMD 20 are passed back to the games console 300 via the cable 82, 84. Similarly, if motion or other sensors are provided at the HMD 20, signals from those sensors may be at least partially processed at the HMD 20 and/or may be at least partially processed at the games console 300. The use and processing of such signals will be described further below.

The USB connection from the games console 300 also provides power to the HMD 20, according to the USB standard.

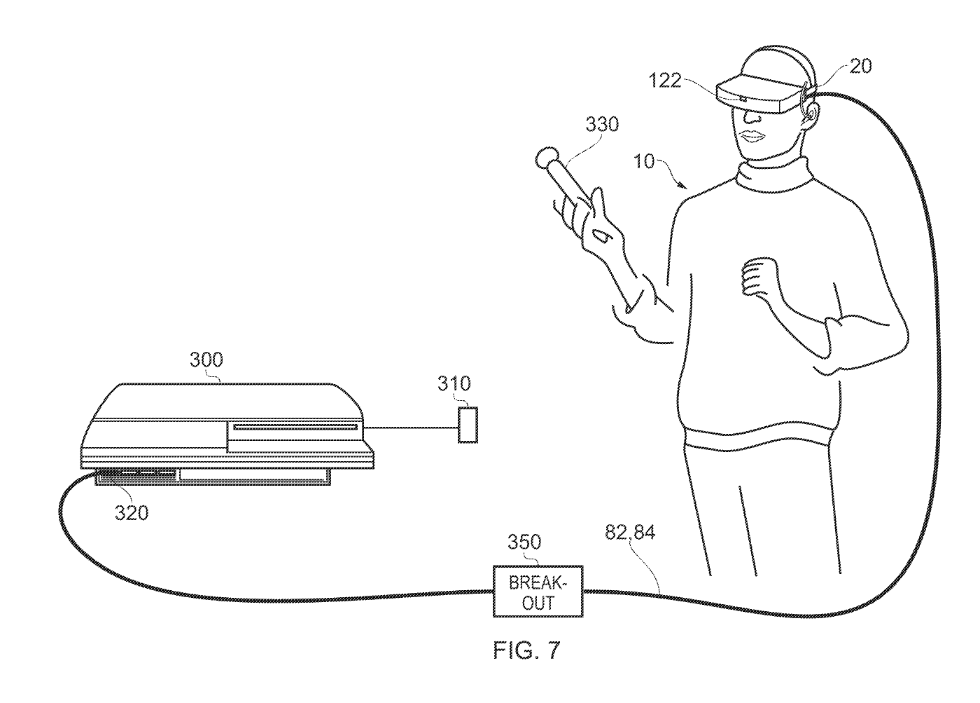

FIG. 7 schematically illustrates a similar arrangement in which the games console is connected (by a wired or wireless link) to a so-called “break out box” acting as a base or intermediate device 350, to which the HMD 20 is connected by a cabled link 82,84. The breakout box has various functions in this regard. One function is to provide a location, near to the user, for some user controls relating to the operation of the HMD, such as (for example) one or more of a power control, a brightness control, an input source selector, a volume control and the like. Another function is to provide a local power supply for the HMD (if one is needed according to the embodiment being discussed). Another function is to provide a local cable anchoring point. In this last function, it is not envisaged that the break-out box 350 is fixed to the ground or to a piece of furniture, but rather than having a very long trailing cable from the games console 300, the break-out box provides a locally weighted point so that the cable 82, 84 linking the HMD 20 to the break-out box will tend to move around the position of the break-out box. This can improve user safety and comfort by avoiding the use of very long trailing cables.

It will be appreciated that the localisation of processing in the various techniques described in this application can be varied without changing the overall effect, given that an HMD may form part of a set or cohort of interconnected devices (that is to say, interconnected for the purposes of data or signal transfer, but not necessarily connected by a physical cable). So, processing which is described as taking place “at” one device, such as at the HMD, could be devolved to another device such as the games console (base device) or the break-out box. Processing tasks can be shared amongst devices. Source signals, on which the processing is to take place, could be distributed to another device, or the processing results from the processing of those source signals could be sent to another device, as required. So any references to processing taking place at a particular device should be understood in this context. Similarly, where an interaction between two devices is basically symmetrical, for example where a camera or sensor on one device detects a signal or feature of the other device, it will be understood that unless the context prohibits this, the two devices could be interchanged without any loss of functionality.

As mentioned above, in some uses of the HMD, such as those associated with virtual reality (VR) or augmented reality (AR) systems, the user's viewpoint needs to track movements with respect to a real or virtual space in which the user is located.

This tracking is carried out by detecting motion of the HMD and varying the apparent viewpoint of the displayed images so that the apparent viewpoint tracks the motion.

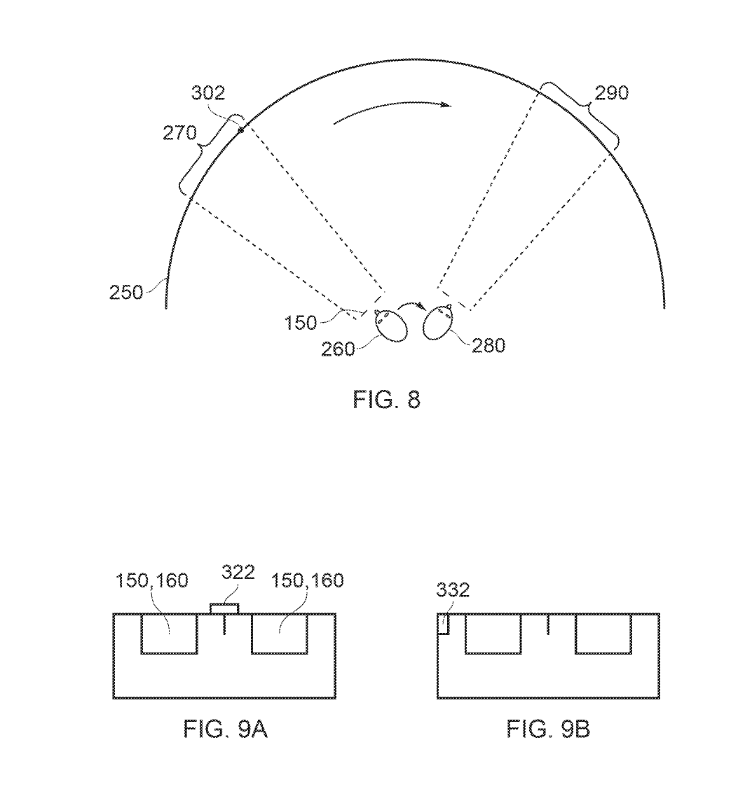

FIG. 8 schematically illustrates the effect of a user head movement in a VR or AR system.

Referring to FIG. 8, a virtual environment is represented by a (virtual) spherical shell 250 around a user. Because of the need to represent this arrangement on a two-dimensional paper drawing, the shell is represented by a part of a circle, at a distance from the user equivalent to the separation of the displayed virtual image from the user. A user is initially at a first position 260 and is directed towards a portion 270 of the virtual environment. It is this portion 270 which is represented in the images displayed on the display elements 150 of the user's HMD.

Consider the situation in which the user then moves his head to a new position and/or orientation 280. In order to maintain the correct sense of the virtual reality or augmented reality display, the displayed portion of the virtual environment also moves so that, at the end of the movement, a new portion 290 is displayed by the HMD.

So, in this arrangement, the apparent viewpoint within the virtual environment moves with the head movement. If the head rotates to the right side, for example, as shown in FIG. 8, the apparent viewpoint also moves to the right from the user's point of view. If the situation is considered from the aspect of a displayed object, such as a displayed object 300, this will effectively move in the opposite direction to the head movement. So, if the head movement is to the right, the apparent viewpoint moves to the right but an object such as the displayed object 300 which is stationary in the virtual environment will move towards the left of the displayed image and eventually will disappear off the left-hand side of the displayed image, for the simple reason that the displayed portion of the virtual environment has moved to the right whereas the displayed object 300 has not moved in the virtual environment.

FIGS. 9a and 9b schematically illustrated HMDs with motion sensing. The two drawings are in a similar format to that shown in FIG. 2. That is to say, the drawings are schematic plan views of an HMD, in which the display element 150 and optical elements 160 are represented by a simple box shape. Many features of FIG. 2 are not shown, for clarity of the diagrams. Both drawings show examples of HMDs with a motion detector for detecting motion of the observer's head.

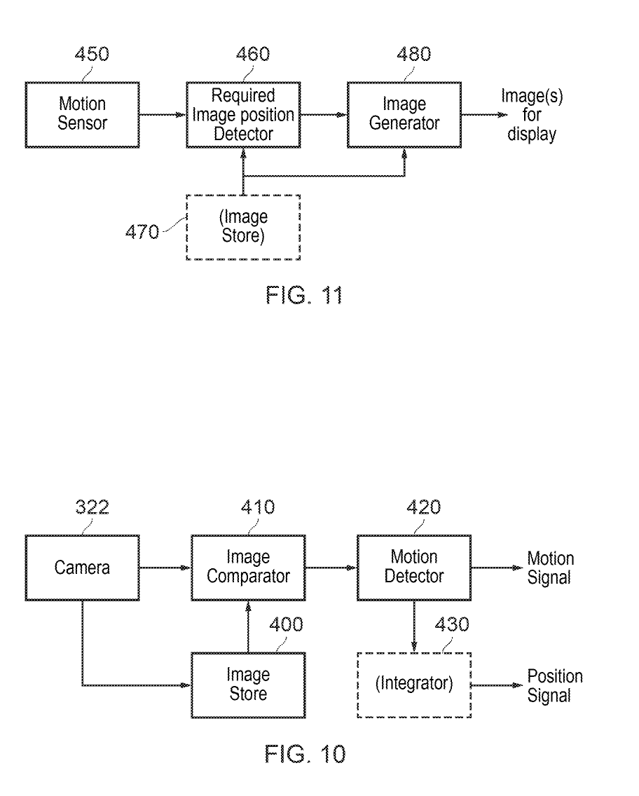

In FIG. 9a, a forward-facing camera 322 is provided on the front of the HMD. This may be the same camera as the camera 122 discussed above, or may be an additional camera. This does not necessarily provide images for display to the user (although it could do so in an augmented reality arrangement). Instead, its primary purpose in the present embodiments is to allow motion sensing. A technique for using images captured by the camera 322 for motion sensing will be described below in connection with FIG. 10. In these arrangements, the motion detector comprises a camera mounted so as to move with the frame; and an image comparator operable to compare successive images captured by the camera so as to detect inter-image motion.

FIG. 9b makes use of a hardware motion detector 332. This can be mounted anywhere within or on the HMD. Examples of suitable hardware motion detectors are piezoelectric accelerometers or optical fibre gyroscopes. It will of course be appreciated that both hardware motion detection and camera-based motion detection can be used in the same device, in which case one sensing arrangement could be used as a backup when the other one is unavailable, or one sensing arrangement (such as the camera) could provide data for changing the apparent viewpoint of the displayed images, whereas the other (such as an accelerometer) could provide data for image stabilisation.

FIG. 10 schematically illustrates one example of motion detection using the camera 322 of FIG. 9a.

The camera 322 is a video camera, capturing images at an image capture rate of, for example, 25 images per second. As each image is captured, it is passed to an image store 400 for storage and is also compared, by an image comparator 410, with a preceding image retrieved from the image store. The comparison uses known block matching techniques (so-called “optical flow” detection) to establish whether substantially the whole image has moved since the time at which the preceding image was captured. Localised motion might indicate moving objects within the field of view of the camera 322, but global motion of substantially the whole image would tend to indicate motion of the camera rather than of individual features in the captured scene, and in the present case because the camera is mounted on the HMD, motion of the camera corresponds to motion of the HMD and in turn to motion of the user's head.

The displacement between one image and the next, as detected by the image comparator 410, is converted to a signal indicative of motion by a motion detector 420. If required, the motion signal is converted by to a position signal by an integrator 430.

As mentioned above, as an alternative to, or in addition to, the detection of motion by detecting inter-image motion between images captured by a video camera associated with the HMD, the HMD can detect head motion using a mechanical or solid state detector 332 such as an accelerometer. This can in fact give a faster response in respect of the indication of motion, given that the response time of the video-based system is at best the reciprocal of the image capture rate. In some instances, therefore, the detector 332 can be better suited for use with higher frequency motion detection. However, in other instances, for example if a high image rate camera is used (such as a 200 Hz capture rate camera), a camera-based system may be more appropriate. In terms of FIG. 10, the detector 332 could take the place of the camera 322, the image store 400 and the comparator 410, so as to provide an input directly to the motion detector 420. Or the detector 332 could take the place of the motion detector 420 as well, directly providing an output signal indicative of physical motion.

Other position or motion detecting techniques are of course possible. For example, a mechanical arrangement by which the HMD is linked by a moveable pantograph arm to a fixed point (for example, on a data processing device or on a piece of furniture) may be used, with position and orientation sensors detecting changes in the deflection of the pantograph arm. In other embodiments, a system of one or more transmitters and receivers, mounted on the HMD and on a fixed point, can be used to allow detection of the position and orientation of the HMD by triangulation techniques. For example, the HMD could carry one or more directional transmitters, and an array of receivers associated with known or fixed points could detect the relative signals from the one or more transmitters. Or the transmitters could be fixed and the receivers could be on the HMD. Examples of transmitters and receivers include infra-red transducers, ultrasonic transducers and radio frequency transducers. The radio frequency transducers could have a dual purpose, in that they could also form part of a radio frequency data link to and/or from the HMD, such as a Bluetooth® link.

FIG. 11 schematically illustrates image processing carried out in response to a detected position or change in position of the HMD.

As mentioned above in connection with FIG. 10, in some applications such as virtual reality and augmented reality arrangements, the apparent viewpoint of the video being displayed to the user of the HMD is changed in response to a change in actual position or orientation of the user's head.

With reference to FIG. 11, this is achieved by a motion sensor 450 (such as the arrangement of FIG. 10 and/or the motion detector 332 of FIG. 9b) supplying data indicative of motion and/or current position to a required image position detector 460, which translates the actual position of the HMD into data defining the required image for display. An image generator 480 accesses image data stored in an image store 470 if required, and generates the required images from the appropriate viewpoint for display by the HMD. The external video signal source can provide the functionality of the image generator 480 and act as a controller to compensate for the lower frequency component of motion of the observer's head by changing the viewpoint of the displayed image so as to move the displayed image in the opposite direction to that of the detected motion so as to change the apparent viewpoint of the observer in the direction of the detected motion.

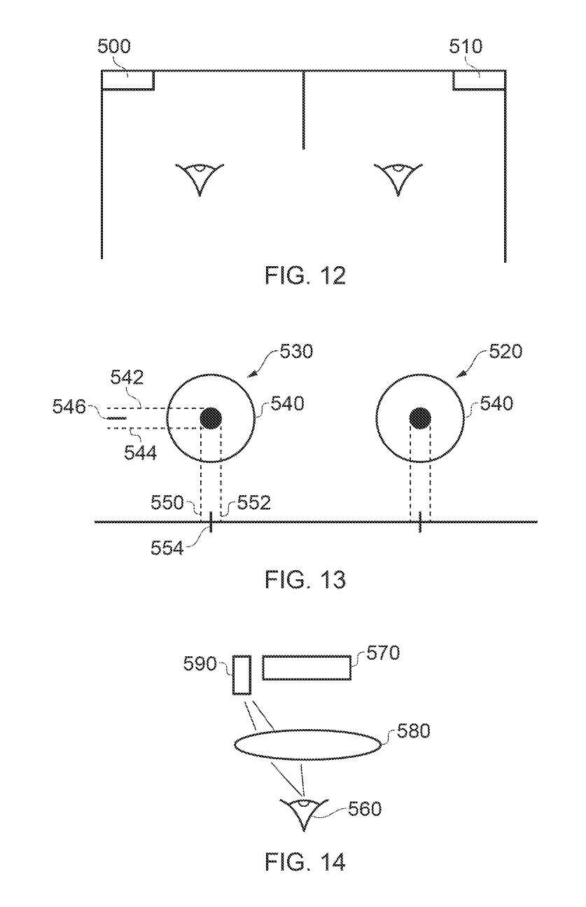

FIG. 12 is a further schematic plan view of an HMD similar to the plan view of FIG. 2 described above. Features already described in connection with that Figure will not be described again. A pair of eye-tracking cameras 500, 510 are provided within the compartments corresponding to each eye tries to generate images of the wearer's eyes in use. Accordingly, the eye-tracking cameras 500, 510 are directed in a backwards direction relative to the orientation of the user's head, so that they look back at the users eyes. Note that the cameras 500, 510 in FIG. 12 can be disposed anywhere with respect to the compartments corresponding to each eye, as long as they do not obscure the users view of the displayed images; they are just shown in the outer corners by way of one schematic example.

To illuminate the users eye, the cameras 500, 510 can rely on illumination provided by the displayed images within the HMD or, if that is insufficient, on infrared or other illumination directed towards the user's eyes.

FIG. 13 schematically illustrates a pair of eye tracking images as captured by the cameras 500, 510. In particular, FIG. 13 shows an image 520 of the users left eye and an image 530 of the users right eye. In general, these will be captured as separate images but are shown alongside one another in FIG. 13 for the purposes of this explanation.

A significant feature to be derived from the captured images 520, 530 is the location of the pupils of the wearer's eyes. Note that the cameras 500, 510 are mounted in a fixed relationship relative to the frame of the HMD, and that, in use, the HMD adopts a fixed relationship to the user's head. Accordingly, from the image position of the pupils within the captured images 520, 530, the position of each pupil relative to the HMD, and therefore relative to the display elements of the HMD, can be directly established.

A first stage in detecting the pupil position is to detect the extent of the iris or coloured portion 540. Then, using known image processing techniques, a central region of the iris is scanned to establish the upper 542 and lower 544 bounds of the pupil (a dark area within the iris) to allow the vertical centre 546 of the pupil to be detected. As a crosscheck, the system establishes whether the vertical centre 546 is also the approximate vertical centre of the iris 540.

To establish the horizontal centre of the pupil, a horizontal scan of the captured image 520, 530 is carried out at the vertical position indicated by the vertical centre 546. This gives left 550 and right 552 boundaries of the pupil, from which a horizontal centre 554 of the pupil can be established.

The horizontal and vertical centres of each pupil, as established by the techniques discussed above, provide a set of coordinates of the pupil position. This detection can be carried out frequently. In embodiments of the invention, the detection is carried out at least as frequently as the image display rate of the display elements of the HMD, so that a next image to be displayed by the HMD can be corrected using techniques to be described below according to the detected pupil positions found by a detection process carried out immediately before the display of that image. In other arrangements, the eye position may be detected less frequently than the image display frequency, but a most-recently detected eye position is used in the correction of each image for display.

For a particular user, a nominal or central eye position may be detected. One way to detect this is for the HMD to display material (such as an instruction which the user has to read) at a central position in the HMD display, and for the eye position detection arrangement to detect the eye position at the time that the user is viewing that centrally displayed information. Similarly, calibration can be carried out to detect the user's eye position when the user is viewing information at various extreme positions (such as each corner) of the HMD display. This calibration can be carried out without the user necessarily knowing, simply by providing information for the user to read at different positions in the HMD display. From the calibration, a mapping between detected eye position and region of the HMD display which the user is viewing can be generated.

Further information can be derived from the images captured by the cameras 500, 510. In particular, a detection of whether the eyes are shut (or one eye shut while the other is open) can be obtained by the lack of a detection of an iris or pupil at or near to the expected position.

In the arrangement of FIG. 12, there was some flexibility in the positioning of the cameras 500, 510 except that they could not obscure the user's view of the display elements of the HMD. A different arrangement is illustrated schematically in FIG. 14. A user's eye 560 views a display element 570 through an optical system shown schematically by a lens 580 but which (as discussed above) may include other optical elements. An eye tracking camera 590 is disposed so as to capture images of the user's eye 560 via at least a part of the optical system 580. So, where the optical system 580 comprises one or more lenses, the camera 590 is disposed so as to capture images of the user's eye through one or more of those lenses. Similarly, if the optical system 580 comprises one or more reflectors, the camera 590 may be disposed so as to capture images of the user's eye via one or more of the reflectors. In the example shown in FIG. 14, the camera 590 is disposed alongside the display element 570, but in other embodiments the camera 590 could be positioned within a compound optical system 580.

In some embodiments, the position of only one eye and its associated pupil is tracked, so that only one of the eye tracking cameras is required. This is on the basis that, for most people, movements of one eye mapped directly to corresponding movements of the other eye. However, a feature of using two cameras is that the results for the pair of eyes can be checked against one another, and that individual detections can be obtained for each of the users eyes.

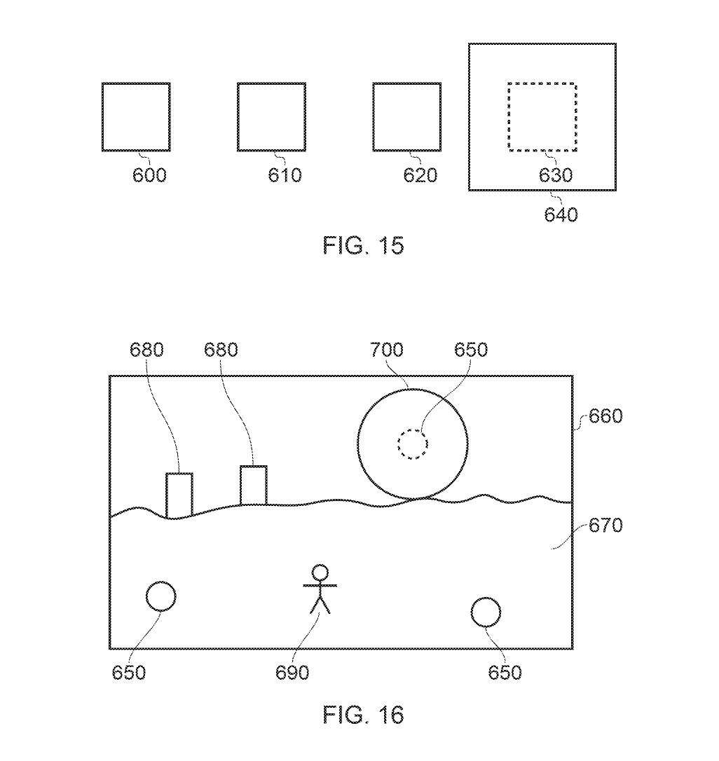

Techniques for using the eye tracking information derived by the arrangements of FIGS. 12-14 will now be described. In the examples to be described with reference to FIGS. 15 and 16, either or both of the eye position (pupil position) and the detection of whether the eyes are open or shut can be used to control operations of the HMD. Examples will be given in FIGS. 15 and 16, but it will be appreciated that the techniques are more widely applicable.

FIG. 15 schematically illustrates a user menu as displayed by the HMD. Multiple menu items are displayed as small boxes 600, 610, 620, 630. Examples of these selectable menu items could include commands such as “restart game”, “reset score”, “invite friend”, “upload score to social media” and the like. The user's pupil position is detected in order to detect which (if any) of the menu items the user is looking at. If it is detected that the user is looking at a particular menu item (possibly with a margin of tolerance around the actual extent of the menu item to allow for inaccuracies in the detected pupil position) then that menu item is displayed differently, as shown schematically as a larger box 640. In one example, the menu item is simply enlarged to indicate that it is currently being looked at. Not only does this confirm the user's selection or provisional selection of the menu item, it also makes it easier for the user to read. In another example, the menu item is moved towards the user in a 3-D display space. The overall result might be that the size, in pixels on the HMD display, of the brought-forward menu item is the same as the size of the enlarged menu item discussed above, but the change in depth associated with bringing the menu item forward can provide a more natural indication to the user that the menu item is selected or provisionally selected. The user can indicate a final selection of the many item by operating a manual user control such as a button or, in some embodiments, by using an eye control such as (a) looking directly from the provisionally selected menu item to a “select” menu item, or (b) closing one or both of the user's eyes for a least a predetermined period such as two seconds.

FIG. 16 schematically illustrates game environment “hotspots”. These relate to the display, within a game environment, of user-selectable information points shown schematically as small circles 650 in FIG. 16. The rectangular area 660 of FIG. 16 schematically represents the extent of the displayed image as seen by the HMD wearer, and it is assumed that the displayed image represents a current game environment including (but purely by way of example) a landscape 670, buildings 680, game characters 690 and the like. The display of the game environment may change according to the current position of the users head, as discussed earlier. However, in some embodiments the game environment hotspots 650 are stationary with respect to the environment, so they move with the environment according to changes in the position of the users head.

The hotspots 650 are designed so as to be small and relatively inconspicuous when not selected. This avoids the hotspots occupying too much of the users view and distracting the user from the game environment. However, if the user looks directly at a hotspot, as detected by the pupil detection process discussed above, the hotspot is expanded from its initial displayed as a small circle into a temporarily displayed wider region 700 containing information to the user. Because the hotspots are locked or located relative to the game environment, the information can be relevant to the particular region of the game environment at which the hotspot is located. Examples here might be user suggestions or clues as to how to deal with a particular game issue (such as dealing with an enemy or exiting from a difficult region). Once the user looks away from the expanded hotspot, the hotspot returns to his previous display size as a small circle. Of course, it will be appreciated that the precise details of how the hotspots are displayed, either in their small or their enlarged state, are open to the skilled person to determine.

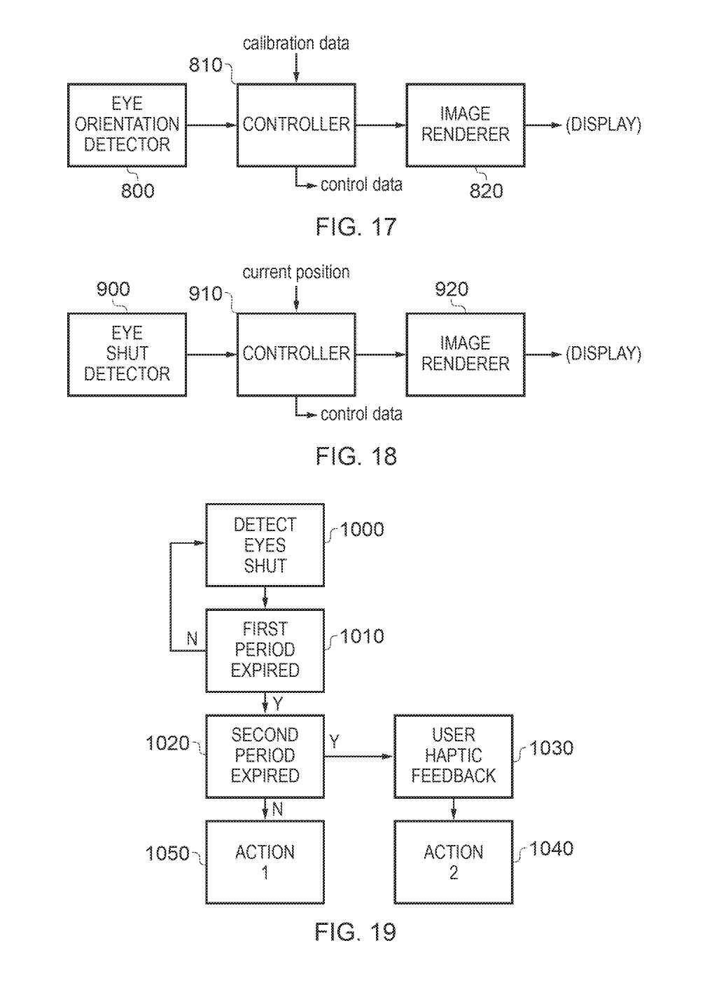

FIG. 17 schematically illustrates a control technique according to eye orientation detection.

In the context of FIG. 17, it is assumed that the current state of a game or other data processing operation is such that a menu of the type discussed above is to be displayed or that the game environment of a current game includes one or more hotspots of the type discussed above.

Referring to FIG. 17, a detector 800 comprises one or two eye tracking cameras of the type described above, along with processing to carry out the steps described with reference to FIG. 13. The output of the detector 800 comprises a set of data defining either or both of: (a) the absolute coordinates or position of one or each pupil (relative to a frame of reference defined relative to the HMD), and (b) deviations of the pupil position(s) from a nominal or expected pupil position.

From the output of the detector 800, a controller 810 detects the image location, with respect to the images being displayed by the HMD, which the user is looking at. The controller 810 can make use of calibration data obtained during a calibration stage as discussed above, in order to provide a mapping between pupil position and image position being looked at.

In the case of the user looking at a final selection menu item such as the “select” item discussed above, the controller can derive control data to be passed to a data processing or game engine to carry out a certain data processing function in response to the user selection.

An image renderer 820 renders a menu item, an enlarged hotspot or other display feature according to the detection, by the controller 810, of the image area of the displayed image at which the user is looking. So, for example, the image renderer might render an enlarged menu item or a brought forward menu item of the type discussed above, an enlarged hotspot or other feature if the user is looking at that image region.

Apart from the features discussed elsewhere in this description relating to the control of items for display, such a system may also detect eye position and/or orientation indicative of an eye impairment. Examples include asymmetric eye movements. A detected impairment can either be compensated for in the display of objects to that user, or can be notified to the user, or both.

FIG. 18 schematically illustrates a control technique according to a detection of whether the eyes are open or shut.

An eyes shut detector 900 makes use of the processing techniques discussed above and the pupil tracking camera(s) to detect whether one or both of the user's eyes are shut. The question of whether to detect one eye being shut or both eyes being shut can be predetermined, in that the user can be instructed that a menu item or the like can be selected by closing one eye for a certain period (such as two seconds) or closing both eyes for that period. An advantage of instructing the user to close only one eye for the certain period is that pupil tracking can be maintained with respect to the other eye during that period in order to be sure that the user is referring to a particular menu item when issuing the “eye shut” command. The predetermined period may be other than two seconds. It is, however, useful if the predetermined period is longer than that associated with a typical blink or other natural eye movement. So, in embodiments of the invention, the predetermined period (used as a threshold to determine whether an eye shut command is being given) is at least, say, 0.4 seconds.

A controller 910 receives data from the detector 900 indicative of an eye shut command. The controller 910 may also receive data (for example, from the detector 800) indicative of a current position, within the image is displayed by the HMD, which the user is looking at, or was looking at the time that the eyes were closed. The controller 910 generates data which is passed to an image renderer 920 to control variations in the images as rendered for display on the HMD, and also generates control data to control data processing or gaming functions in response to the eyes shut command.

Note that the selection of an operation in response to detection of an eyes shut command does not have to involve a menu of the type shown in FIG. 15; there could be a default action which is carried out in response to detection of an eyes shut command. The default action could be represented by a single menu item temporarily or permanently displayed on the screen, or could correspond to an action not represented by a displayed many item.

As discussed above, the eyes shut command does not take effect for at least a predetermined period, in some embodiments. If both eyes are shut, then clearly the user cannot see what is displayed on the display of the HMD during that period. However, if the arrangement is such that the eyes shut command actually involves shutting one eye but keeping the other eye open, then during that predetermined period, it may be appropriate to indicate to the user (or at least to the users open eye) that an eyes shut command is about to be executed. So, during that predetermined period, the display of the currently selected menu item, or another aspect of the display in general, may be varied so as to indicate that a provisional eyes shut command is being processed, and will take effect at the end of the predetermined period. For example, in the case of a menu item which is to be selected by the eyes shut command, the menu item can be highlighted, changed in colour, “wobbled” or varied in positioned on the display, or otherwise changed so as to indicate that at the end of the predetermined period that menu item will be finally selected.

The eyes shut command does not need to relate to a currently displayed menu item. For example, if the user shuts his eyes for a least a predetermined period (which could be different to the period associated with the selection of the many item, for example being longer than that period, for example for seconds) this could cause various different actions such as a game pause, a change from 3-D to 2-D display, a system restart or reset or the like.

FIG. 19 is a schematic flowchart illustrating operations of the apparatus of FIG. 18.

In the apparatus of FIG. 19, two different time periods over which the users eyes are shut are detected. It will, of course, be clear that multiple different time periods could be detected using exactly the same principles, and that the selection of two different time periods for the diagram of FIG. 19 is merely for clarity of the present description.

The two different time periods, when detected during an eyes-shut incident or episode, lead to two different actions being carried out. The actual choice of actions is for the system designer to implement, and given that the present description relates to the manner of detecting and triggering the actions rather than the actions themselves, the specific choice is, in most cases, immaterial. One example however where the choice is relevant to the technology of an HMD is that a user shutting his or her eyes for the second (longer) period under detection can lead to the user leaving or exiting the virtual reality experience which the user is currently engaged in. In the case of a computer game system in which an HMD is used for an immersive experience, this can provide a useful means of the user leaving such an immersive experience.

Turning to FIG. 19, at a step 1000 the eye shut detector 900 of FIG. 18 detects that the eyes are shut. In this particular example, a detection is made that both eyes are shut, but this need not be the case. A detection of a particular eye or either eye could be made.

At a step 1010 it is detected whether the eyes have been shut for a first period. An example of the first period is 0.4 seconds. If the eyes are shut for less than the first period then control returns to the step 1000 and the particular episode of the eyes being shot is treated as a blink rather than a command. If however the first period has expired and the eyes remain shut, then control passes to a step 1020.

At the step 1020, a test is made as to whether the eyes have continuously been shut for a second period. The second period is longer than the first period but is treated (in this example) as having started at the same time, although it will of course be appreciated that the second period could be timed from the expiry of the first period. An example of the second period is one second.

If the outcome of the step 1020 is that the eyes were continuously shut for the second (longer) period then control passes to a step 1030 at which so-called haptic feedback is provided to the user. This can be in the form of an audio indication such as a beep in the user's earpieces, or could be a tactile sensations such as a vibration in a vibrating actuator mounted in or on the HMD, or the like. Then, control passes to a step 1040 at which a particular action (labelled here as “action 2”) associated with the eyes be shut for a second period is carried out. As discussed above, one example of a second action is to exit the virtual reality experience, although other examples could include selecting menu items or commands, for example based upon the latest (before the eyes were shut) direction of gaze of the user's eyes.

If, however, at the step 1020 it is detected that the second period had not expired, then control passes to a step 1050 at which a first action difference to the second action (and labelled here as “action 1”) is carried out. Note that in order for the flow of control to reach the step 1020, the first period had already expired with the eyes shut, and that the flow of control to reach the step 1050 means that the eyes were shut for at least the first predetermined period but for less than the second predetermined period.

Accordingly, this system provides an example of a head mountable display (HMD) system in which images are generated for display to the user, the HMD system comprising:

an eyes-shut detector configured to detect a user's eye or eyes being shut; and

an image generator configured to generate images for display by the HMD, the image generator being configured to carry out actions in response, at least in part, to a detection of whether the HMD wearer has one or both eyes shut for at least a first predetermined period, the image generator executing different respective actions in dependence upon:

(i) a detection that the user's eyes are shut for at least the first predetermined period but less than a second predetermined period, the second predetermined period being longer than the first predetermined period; and

(ii) a detection that the user's eyes are shut for at least the second predetermined period.

It will be appreciated that the actions can relate to (or at least can result in) image generation actions.

The steps of FIG. 19, including the detections at the steps 1010 and 1020, are carried out by the eyes shut detector 900 and/or the controller 910 of FIG. 18.

Referring to the haptic feedback in the step 1030, this can be advantageously aligned with the position, within the virtual world represented by the HMD display, of the action triggered by the user at the step 1040. For example, if the step 1040 relates to activation of a command or many item which is displayed to one side of the HMD display, the haptic feedback can be provided at that side of the user's hearing (in the case of a beep) or head. (In the case of a vibration). This can provide confirmation to the user that the user has activated that particular control or command, something which can be useful given that the user, by this stage, will have had his or her eyes shut for at least the second period. Similarly, a different haptic feedback may be useful in association with the action 1 at the step 1050.

In further alternative embodiments, using 3D image displays, the depth position which the user is currently viewing can be detected by the eye position detectors being arranged to detect the so-called vergence (convergence or divergence) of the user's eyes. Even though the position at which a virtual image is displayed is fixed (for example at infinity) in many 3D displays, the illusion of 3D will cause the user's eyes to converge according to the perceived depth of a displayed item. In an example where a menu item is displayed at a certain depth, the activation by the user of that menu item or control can be detected by a detection of whether the user is looking in that direction and whether the user's vergence corresponds (within a threshold tolerance) to the depth associated with that menu item.

In some embodiments, the system is operable to render displayed items with a degree of focus depending on whether the vergence indicates that the user is looking at a displayed object at that depth. So, if a user is looking to a particular depth, displayed items at that depth are displayed without any defocusing. For other displayed items at other depths, a degree of defocus is applied which is, for example, dependent upon the depth disparity between the depth of that item and the depth indicated by the user's vergence, so that (for example) the defocus increases with increasing depth disparity.

In another example, in a games system involving operating a virtual weapon such as a virtual gun (for example, a so-called “first person shooter” game), activation of the weapon can be initiated in response to a detection that one eye is closed and one eye open (as the user might do if looking down a gun sight). In response to such a detection, a weapon could be initiated and displayed, and/or a weapon could be cocked ready for use.

Overall, advantages of the present embodiments with respect to other eye tracking systems are that the eye tracking detectors move with the user's head, and that (with reference to FIG. 14, for example) the optical elements already in place to provide the HMD display can also provide magnification (when used in the opposite direction) for capturing images of the user's eyes for eye position and eyes shut detection.

Accordingly, embodiments of the present invention can provide a head mountable display (HMD) system in which images are generated for display to the user, with the image generation being controlled, at least in part, according to the detection of the eye position and/or orientation of the HMD wearer, and/or whether the HMD wearer has one or both eyes shut for at least a predetermined period.

In embodiments of the invention, the HMD may comprise one or more cameras directed (in use) at the wearers eyes, and a detection arrangement associated with the cameras to detect either or both of the eye position and/or orientation, and whether one or both eyes are shut.

In embodiments of the invention, the display of one or more image features can be changed according to whether or not the user is currently looking at those image features. For example, the image features may be menu items or information items. Such an item can be made more prominent on the display if the user is looking at it. For example, such an item can be enlarged and/or brought forward (in a 3-D display space) if the user is looking at it. The enlarged and/or brought forward item can include more information than the item before being enlarged or brought forward.

A detection of one or both eyes being shut can be used to indicate selection of a displayed item which the user is currently looking at, or which is displayed as a default action. The detection may be with respect to a predetermined period longer than that associated with a natural eye movements such as a blink. During the predetermined period, the display of the item or action which will be carried out at the end of the predetermined period can be changed so as to indicate its provisional selection. Detection of one or both eyes being shut for a second predetermined period longer than the first mentioned predetermined period may cause a different data processing action to be carried out.

In embodiments, the HMD is operable to detect the vergence of the user's eyes in order to detect a depth at which the user is currently looking.

In embodiments the HMD is operable in respect of a video game in which a virtual weapon may be provided, is operable to detect one eye shut and one eye open, and in response to such a detection, is operable to activate the virtual weapon for use.

Embodiments of the invention also provide a system comprising an HMD and one or more of a base device such as a games console and an intermediate device such as a break-out box.

Embodiments of the present invention can also provide a method of operation of head mountable display (HMD) in which images are generated for display to the user, comprising controlling the image generation, at least in part, according to the detection of the eye position and/or orientation of the HMD wearer, and/or whether the HMD wearer has one or both eyes shut for at least a predetermined period.

It will be appreciated that the various techniques described above may be carried out using software, hardware, software programmable hardware or combinations of these. It will be appreciated that such software, and a providing medium by which such software is provided (such as a machine-readable non-transitory storage medium, for example a magnetic or optical disc or a non-volatile memory) are considered as embodiments of the present invention.

Obviously, numerous modifications and variations of the present disclosure are possible in light of the above teachings. It is therefore to be understood that within the scope of the appended claims, the invention may be practiced otherwise than as specifically described herein.

1. A head mountable display (HMD) system in which images are generated for display to a user of the HMD, the HMD system comprising:
an eyes-shut detector configured to detect the HMD user's eye or eyes being shut; and
an image generator configured to generate images for display by the HMD, the image generator being configured to carry out actions in response, at least in part, to a detection of whether the HMD user has one or both eyes shut for at least a first predetermined period,
the image generator executing different respective actions in dependence upon:
(i) a detection that the user's eyes are shut for at least the first predetermined period but less than a second predetermined period, the second predetermined period being longer than the first predetermined period; and
(ii) a detection that the user's eyes are shut for at least the second predetermined period.

2. A system according to claim 1, in which the HMD comprises one or more cameras directed, in use, at the user's eyes, and a detection arrangement associated with the cameras to detect either or both of an eye position and orientation, and whether one or both eyes are shut.

3. A system according to claim 2, in which the image generator is responsive to the detection of one or both of the eye position and orientation of the HMD user.

4. A system according to claim 1, in which the display of one or more image features is changed according to whether or not the user is currently looking at those image features.

5. A system according to claim 4, in which the image features are menu items or information items.

6. A system according to claim 5, in which an image feature is made more prominent on the display if the user is detected to be looking at it.

7. A system according to claim 6, in which an image feature is made more prominent on the display by the image feature being at least one of enlarged and brought forward in a 3-D display space if the user is detected to be looking at it.

8. A system according to claim 1, in which a detection of one or both eyes being shut for either the first or second predetermined period indicates selection of a displayed item which the user is detected to be currently looking at, or which is displayed as a default action.

9. A system according to claim 8, in which the first predetermined period is longer than that associated with a natural eye movement.

10. A system according to claim 9, the system being confiured to change, during the first predetermined period, the display of the item or action which will be carried out at an end of the first predetermined period so as to indicate a provisional selection thereof.

11. A system according to claim 1, the HMD being configured to detect a vergence of the user's eyes in order to detect a depth at which the user is currently looking.

12. A system according to claim 11, in which the system is configured to render displayed items with a degree of focus depending on whether the vergence indicates that the user is looking at a displayed object at that depth.

13. A system according to claim 1, the system being configured to detect one or both of eye position and orientation indicative of an eye impairment.

14. A system according to claim 1, configured in respect of a video game in which a virtual weapon may be provided, configured to detect one eye shut and one eye open, and in response to such a detection, to activate the virtual weapon for use.

15. A method of operation of head mountable display (HMD) in which images are generated for display to the user, comprising controlling the image generation, at least in part, according to a detection of whether the HMD user has one or both eyes shut for at least a first predetermined period, the method comprising performing different respective actions in dependence upon:
(i) detecting that the user's eyes are shut for at least the first predetermined period but less than a second predetermined period, the second predetermined period being longer than the first predetermined period; and
(ii) detecting that the user's eyes are shut for at least the second predetermined period.

16. A non-transitory machine-readable storage medium which stores computer software which, when executed by a computer, causes the computer to carry out the method of claim 15.
